(19) United States
(12) Patent Application Publication
(10) Pub. No.: US 2007/0013728 A1
(43) Pub. Date: Jan. 18, 2007

(54) Ink level detecting apparatus of image forming apparatus

(75) Inventor: Sung-june Jung, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/476,727

(22) Filed: Jun. 29, 2006

(30) Foreign Application Priority Data
Jul. 15, 2005 (KR) 2005-64065

(51) Int. Cl. B41J 2/195

(52) U.S. Cl. 347/7

(57) ABSTRACT

An ink level detection apparatus of an image forming apparatus. The ink level detection apparatus includes an ink tank having a light receiving sensor and a light source disposed such that an intensity of light emitted toward the light receiving sensor changes as a height of a contracting type ink pack changes.

### CROSS-REFERENCE TO RELATED APPLICATIONS

This application claims priority under 35 U.S.C. §119(a) from Korean Patent Application No. 10-2005-0064065, filed on Jul. 15, 2005 in the Korean Intellectual Property Office, the disclosure of which is incorporated herein in its entirety by reference.

### BACKGROUND OF THE INVENTION

1. Field of the Invention

The present general inventive concept relates to an ink level detecting apparatus of an image forming apparatus (such as an inkjet printer), and more particularly, to an ink level detecting apparatus having a contracting type ink pack, a height of which changes depending on a level of remaining ink, a light source disposed such that a location on which light is incident changes as the height of the contracting type ink pack changes, and a light receiving sensor.

2. Description of the Related Art

Generally, in an inkjet printer, ink contained in an ink tank is supplied to an ink ejecting unit having ink ejecting heads via a predetermined ink supply path, and then the ink is ejected via the ink ejecting heads in micro droplets. Therefore, as the inkjet printer performs a printing job, a level of the ink remaining inside the ink tank decreases.

Accordingly, a relatively accurate measurement of the ink remaining in the ink tank, that is, the ink level, is required. In particular, when the ink level is close to the floor of the ink tank and there is not enough ink in the ink tank, the printer should inform a user of this situation and a printing of a new page should be stopped. Reasons to stop printing a new page include the following.

If ink is ejected until all of the ink is exhausted, an ink ejecting head can get damaged. For example, when a thermal method is used to eject ink, a heating element is rapidly heated to heat the ink accommodated inside of an ink cell to expand the ink and force an ink droplet out of a nozzle. If the heating element is heated when there is no ink inside the ink cell, the heating element or peripheral elements may get damaged. Therefore, an allowable minimum amount of ink remaining in the ink cell must be reliably detected in order to prevent damage of the ink heads.

In addition, when ink is exhausted and a printing job is stopped in the middle thereof, a partially printed paper and ink printed thereon will be discarded. Thus, whether there is enough ink for printing at least one page should be detected before printing.

Examples of conventional devices for detecting a level of ink are disclosed in U.S. Pat. No. 5,997,121 and Japanese Patent Publication No. 1994-099588. The former discloses a low ink sensing system including two light sources and one photodetector, wherein a level of ink is detected via a difference in amounts of light reflected by an ink container inclined at various levels. The latter discloses an ink run-out detector which detects whether a level of ink is at a predetermined level using reflection type optical switches including a light source and a photodetector.

However, the conventional devices merely indicate whether an ink level has reached a predetermined critical level. That is, the conventional devices do not inform a user of a current ink level in an image forming apparatus (e.g., an inkjet printer) before the ink level reaches the critical level. Thus, the user cannot predict when the ink will be exhausted using the conventional devices.

### SUMMARY OF THE INVENTION

The present general inventive concept provides an ink level detecting apparatus of an image forming apparatus, which can continuously detect a level of ink before the ink level reaches a critical level using a light source and a light receiving sensor.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing an ink level detection apparatus of an inkjet image forming apparatus, including an ink tank, a contracting type ink pack accommodated in the ink tank and having a top surface to be lowered in a substantially horizontal direction as an amount of ink in the contracting type ink pack decreases, a light source disposed on the top surface of the contracting type ink pack to emit light in a direction, and a light receiving sensor disposed on a sidewall of the ink tank to sense the intensity of the light emitted from the light source.

The light emitted from the light source may be incident on the sidewall of the ink tank, and a center of a region of the sidewall on which the light is incident may change according to a height of the contracting type ink pack. A light intensity distribution within the region on which the light is incident, that is, a power spectrum, may have a maximum value in the center of the region and an intensity may decrease in a predetermined pattern as the light moves further away from the center of the region.

A shape of the power spectrum may depend on the characteristics of the light source. The light source may be an LED or a and laser diode. Information on the power spectrum of the light source can be obtained by measuring a power at different locations in the region on which the light is incident. Conversely, if the power spectrum of a particular light source is known, a distance from a certain point to a center of the power spectrum can be estimated according to an intensity of light sensed at the certain point.

The foregoing and/or other aspects and utilities of the present general inventive concept may also be achieved by providing an ink level detection apparatus of an inkjet image forming apparatus, including an ink tank, a contracting type ink pack accommodated in the ink tank and having a top surface to be lowered in a substantially horizontal direction as an amount of ink remaining in the contracting type ink pack decreases, a light source disposed on a ceiling of the ink tank to emit light towards the top surface of the contracting type ink pack, a reflection mirror disposed on the top surface of the contracting type ink pack to reflect incident light thereon from the light source towards a direction, and a light receiving sensor disposed on a sidewall of the ink tank to sense the intensity of the light emitted from the light source and reflected by the reflection mirror.

The light source can be fixed to the ink tank, and power can thus be easily supplied to the light source. A concave reflection mirror can be used as the reflection mirror to condense the light.

The foregoing and/or other aspects and utilities of the present general inventive concept may also be achieved by providing an ink level detection apparatus of an inkjet image forming apparatus, including an ink tank, a contracting type ink pack accommodated in the ink tank and having a top surface that is lowered in a substantially horizontal direction as an amount of ink remaining in the contracting type ink pack decreases, a light source disposed on the top surface of the ink tank to emit light in a substantially parallel direction, a convex lens fixed with respect to the light source and disposed in an optical path of the light emitted from the light source, and a light receiving sensor fixed with respect to the ink tank, and which senses the intensity of the light emitted from the light source through the convex lens.

The foregoing and/or other aspects and utilities of the present general inventive concept may also be achieved by providing a detecting unit to detect an ink level in an image forming apparatus, including a light emitting unit to emit light having a spectrum of intensities, a light receiving unit to receive a portion of the light emitted by the light generating unit and to generate electrical signals corresponding to an intensity of the received portion of the light, and a control unit to determine an ink level using the electrical signals.

The intensity of the received portion of light may correspond to a distance between the light emitting unit and the light receiving unit. The control unit may continuously determine the ink level at predetermined time intervals. The control unit may determine the ink level before the ink level reaches a predetermined critical level. The intensity of the received portion of the light may have a predetermined relationship with a size of an ink storage unit to store the ink.

A position of the light emitting unit may be moveable with respect to the ink level. The moveable light emitting unit may emit the light directly towards the light receiving unit. The position of the light emitting unit may be fixed with respect to the ink level. The detecting unit may further include a light modifying unit to modify the light emitted by the light emitting unit. The light modifying unit may include a reflecting unit to reflect the light emitted by the light emitting unit towards the light receiving unit. The light modifying unit may include a refracting unit to refract the light emitted by the light emitting unit towards the light receiving unit.

The intensity of the light emitted by the light emitting unit may decrease in proportion to an increase in a distance between the light emitting unit to the light receiving unit. The intensity of the light emitted by the light emitting unit may decrease in inverse proportion to a square of a distance between the light emitting unit to the light receiving unit. The light receiving unit may have a higher sensitivity to a wavelength of the light emitted from the light emitting unit relative to other wavelengths of light.

The foregoing and/or other aspects and utilities of the present general inventive concept may also be achieved by providing an ink level detection device useable in an image forming apparatus, including a contractible ink storage part to store ink, a light receiving part to receive light, to generate electrical signals corresponding to an intensity of the received light, and to determine a level of the ink in the contractible ink storage part using the electrical signals, and a light emitting part to emit the light towards the light receiving part such that an intensity of the light received by the light receiving part changes as the ink storage part contracts. The intensity of the light may correspond to a distance between the light emitting part and the light receiving part. The light emitting part may emit the light directly to-the light receiving part. The light receiving part may continuously determine the ink level in real-time.

The foregoing and/or other aspects and utilities of the present general inventive concept may also be achieved by providing a method of detecting a level of ink in a deformable storage unit of an image forming apparatus, including emitting light towards a light sensor such that an intensity of the light received by the light sensor changes as a shape of the ink storage part changes, generating electrical signals corresponding to the intensity of the received light, and determining a level of the ink in the deformable ink storage part using the electrical signals. The intensity of the received light may correspond to a size of the deformable ink storage part.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a view illustrating an ink level detecting apparatus, according to an embodiment of the present general inventive concept;

FIG. 2 is a view illustrating characteristics of a light power spectrum of a region in the image forming apparatus of FIG. 1;

FIG. 3 is a view illustrating an ink level detecting apparatus, according to another embodiment of the present general inventive concept; and

FIGS. 4A and 4B are views illustrating an ink level detecting apparatus, according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

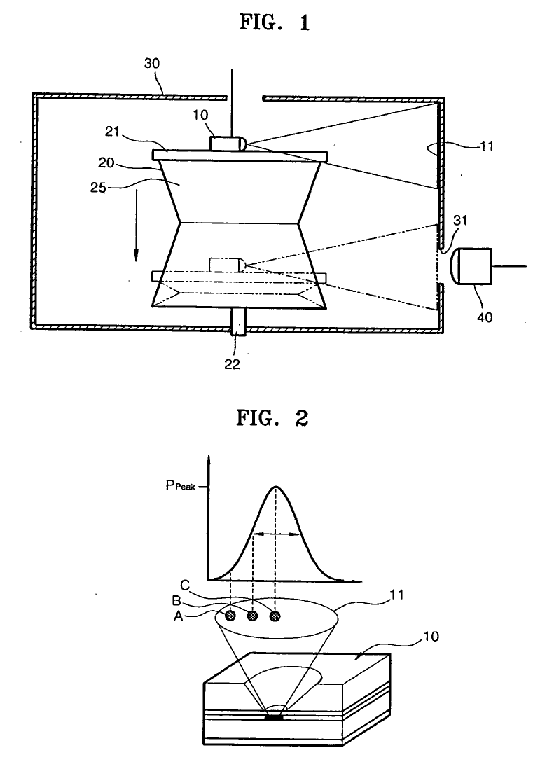

FIG. 1 is a view illustrating an ink level detecting apparatus according to an embodiment of the present general inventive concept. According to the present embodiment, a contracting type ink pack 20 is provided in an ink tank 30 installed in an inkjet printer. The ink tank 30 is a housing accommodating the contracting type ink pack 20, and can be made of various materials. For example, the ink tank 30 may be made of plastic so that its shape and inner structure can be easily formed. The contracting type ink pack 20 can be composed of stacked films having aluminum layers, includes an outlet 22 through which ink is discharged, and has at least one crease formed on a side thereof. A height of a top surface of the contracting type ink pack 20 is lowered with respect to a bottom surface of the contracting type ink pack 20 as a depth of the crease increases when a level of ink 25 in the contracting type ink pack 20 decreases. A conventional contracting type ink pack having such characteristics may be used.

A light source 10 is mounted on the top surface of the contracting type ink pack 20 to emit light in a direction (e.g., in one direction). A reinforcement plate 21, to maintain flat the top surface of the contracting type ink pack 20, may be formed on top of the contracting type ink pack 20. In this case, the light source 10 is disposed on the reinforcement plate 21. The light source 10 may be any light emitting element which emits light that can be sensed by a light receiving sensor 40, for example, a light emitting diode (LED) or a laser diode.

The light emitted from the light source 10 diffuses as it propagates, and reaches a predetermined region 11 of a sidewall of the ink tank 30, as illustrated in FIG. 1. However, since the height of the contracting type ink pack 20 decreases as the ink 25 inside the contracting type ink pack 20 is consumed, a height of the light source 10 is lowered, and thus the region 11 on which the light is incident moves downward.

The light receiving sensor 40, which senses an intensity of the light emitted by the light source 10, is disposed at the sidewall of the ink tank 30 where the light reaches. A hole 31 may be formed in the sidewall of the ink tank 30 to install the light receiving sensor 40. The light receiving sensor 40 generates electrical signals according to the intensity of light, that is, a light power level. The light receiving sensor 40 may have a higher sensitivity to a wavelength of light emitted from the light source 10 relative to a wavelength of other light (i.e., wavelengths of light not emitted by the light source 10). For example, if the light source 10 emits blue light, the light receiving sensor 40 may have a higher sensitivity to blue light than to other colored light, such as green light, red light, etc.

A principle to detect the height of the contracting type ink pack 20 according to this embodiment, that is, the ink level, is as follows.

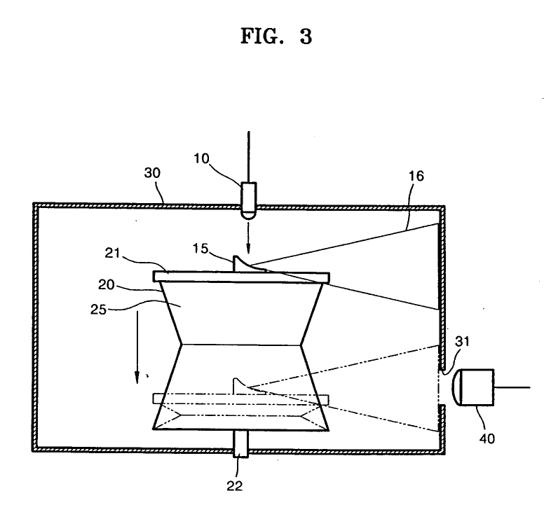

Characteristics of the light source 10 will be described first. FIG. 2 is a view illustrating characteristics of a power spectrum of the light emitted by the light source 10. A schematic view of an LED or a laser diode is illustrated at the bottom in FIG. 2. Light is emitted from a narrow region of the light source 10, having a diameter of, for example, several micrometers, and diffuses as it propagates. Therefore, the light is incident on the region 11 separated from the light source 10 by a predetermined distance. The region 11 is larger than the narrow region from which the light is emitted.

A graph above the region 11 in FIG. 2 illustrates a distribution of light intensity, that is, the power spectrum, in the region 11 in the image forming apparatus of FIG. 1. Point C corresponding to a center of the light source 10 is a center of the power spectrum where the power (i.e., the intensity) is at a maximum (Pₚₑₐₖ), and the power of the incident light decreases as it gets further away from the center. Thus, ½ of the maximum power is detected at point B and power almost equal to 0 is detected at point A. As such, the power of the incident light has a predetermined relationship with the distance from the center of the region 11. When information on a power spectrum of a light source is known, how far any point in the region 11 is from the center of the region 11 can be determined using a power detected at that point.

In this embodiment of the present general inventive concept, the region 11 on which the light is incident moves downwards together with the top surface of the contracting type ink pack 20. Thus, the distance obtained using the power spectrum information and the power detected by the light receiving sensor 40 is the distance from where the light receiving sensor 40 is installed to the top surface of contracting type ink pack 20 (i.e., to the light source 10 thereon). Consequently, the ink level can be detected using an electrical signal corresponding to the level of the light receiving sensor 40 with respect to the light source 10.

The ink level detected as described above may be used as a reference value to control an image forming device (e.g., an inkjet printer) containing the ink level detecting apparatus. For example, a warning message to inform a user that the ink has been exhausted when the ink level has reached a predetermined critical level or to stop printing a new page can be generated.

FIG. 3 is a view illustrating an ink level detecting apparatus according to another embodiment of the present general inventive concept. In the present embodiment, the ink level detecting apparatus includes a light source 10 disposed on a ceiling of an ink tank 30 to emit light to a top surface of a contracting type ink pack 20, and a reflection mirror 15 provided on the top surface of the contracting type ink pack 20 to reflect incident light 16 output from the light source 10 in a direction (e.g., in one direction).

A principle to detect the ink level in this embodiment is the same as in the embodiment previously described with reference to FIG. 1, but the present embodiment is different from the previous embodiment in that the light source 10 is fixed (in contrast to the moveable light source 10 illustrated in FIG. 1, which is moveable with a contraction of the contraction type ink pack 20 of FIG. 1) to enable an easy power connection thereto, and the reflection mirror 15 moves as the height of the contracting type ink pack 20 changes to achieve a similar effect as if the light source 10 is moving. A signal level of the light 16 in this embodiment may be lower relative to the signal level of the previous embodiment because an optical path from the light source 10 to the light receiving sensor 40 in this embodiment is longer relative to the optical path in the previous embodiment. In particular, the light in the previous embodiment travels directly from the light source 10 to the light receiving sensor 40, whereas the light 16 in this embodiment travels from the light source 10 to the reflection mirror 15 and then to the light receiving sensor 40. However, this issue can be addressed by using a convex reflection mirror as the reflection mirror 15 to condense the light.

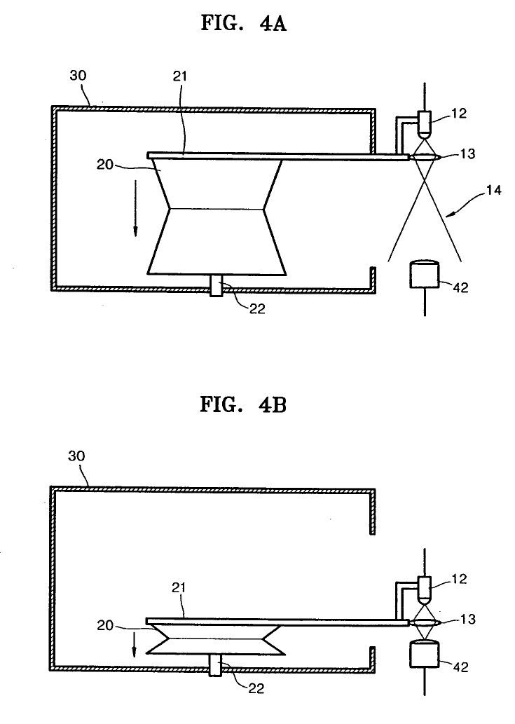

FIGS. 4A and 4B are views illustrating an ink level detecting apparatus according to another embodiment of the present general inventive concept. In the present embodiment, the ink level detecting apparatus includes a light source 12 to emit light 14 vertically downwards from above a top surface of a contracting type ink pack 20, a convex lens 13 which refracts the light 14 emitted from the light source 12 into a focus direction, and a light receiving sensor 42 which senses an intensity of the light 14 incident on the light receiving sensor 42 through the convex lens 13.

The light source 12 illustrated in FIGS. 4A and 4B is disposed to emit light in a vertical downwards direction. For example, the light source 12 may be disposed on one side of a reinforcement plate 21 disposed on the top surface of the contracting type ink pack 20, as illustrated in FIG. 4A, and emit light downwards. Alternatively, in other embodiments, the light source 12 may be disposed on the top surface of the contracting type ink pack 20 to emit light upwards towards a ceiling of an ink tank 30.

The light receiving sensor 42 is disposed on the optical path of the light source 12 and the convex lens 13. The light 14 which passed through the convex lens 13 is diffused and propagates as illustrated in FIG. 4A. Accordingly, the intensity of the light 14 weakens in inverse proportion to a square of a distance to the light receiving sensor 42. The intensity of the light 14 incident on the light receiving sensor 42 can be sensed using such a relationship, thereby detecting a height of the contracting type ink pack 20, which corresponds to the ink level.

FIG. 4B illustrates a case when the ink level reaches a predetermined critical level. Here, locations of the light source 12, the convex lens 13, and the light receiving sensor 42 can be determined to maximize the intensity of the light 14 condensed by the convex lens 13, that is, a light power.

In various embodiments of the present general inventive concept, a detecting unit may include a light receiving sensor, which is fixed, and a light source disposed so that an intensity of light incident on the light source varies according to a change in a height of a contracting type ink pack. The intensity of the light sensed at the light receiving sensor has a predetermined relationship with the height of the contracting type ink pack. Thus, an ink level at a time of measurement can be detected using the sensed signal level and the predetermined relationship. Therefore, the ink level can be detected even before the ink level reaches a certain level, such as, a predetermined critical level at which an ink ejecting unit needs to be protected. In addition, a time when an ink tank needs to be refilled or a number of pages that can be printed using a remaining ink can be predicted by continuously detecting the ink level.

An ink level detection apparatus according to the present general inventive concept can continually detect a level of ink before the ink level of an inkjet printer reaches a predetermined critical level. Therefore, a user can determine the ink level in real time and can predict approximately when the ink will be exhausted using the ink level detection apparatus.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An ink level detection apparatus of an inkjet image forming device, comprising:
an ink tank;
a contracting type ink pack accommodated in the ink tank and having a top surface to be lowered in a substantially horizontal direction as an amount of ink in the contracting type ink pack decreases;
a light source disposed on the top surface of the contracting type ink pack to emit light in a direction; and
a light receiving sensor disposed on a sidewall of the ink tank to sense an intensity of the light emitted from the light source.

2. The ink level detection apparatus of claim 1, wherein the contracting type ink pack comprises:
a reinforcement plate disposed on the top surface of the contracting type ink pack to maintain flat the top surface thereof,
wherein the light source is disposed on the reinforcement plate.

3. The ink level detection apparatus of claim 1, wherein the light source is an LED or a laser diode.

4. The ink level detection apparatus of claim 1, wherein the light receiving sensor has a high sensitivity to a wavelength of the light emitted from the light source relative to a different light wavelength.

5. An ink level detection apparatus of an inkjet image forming device, comprising:
an ink tank;
a contracting type ink pack accommodated in the ink tank and having a top surface to be lowered in a substantially horizontal direction as an amount of ink remaining inside of the contracting type ink pack decreases;
a light source disposed on a ceiling of the ink tank to emit light towards the top surface of the contracting type ink pack;
a reflection mirror disposed on the top surface of the contracting type ink pack to reflect light incident thereon from the light source towards a direction; and
a light receiving sensor disposed on a sidewall of the ink tank to sense an intensity of the light emitted from the light source and reflected by the reflection mirror.

6. The ink level detection apparatus of claim 5, wherein the contracting type ink pack comprises:
a reinforcement plate disposed on the top surface of the contracting type ink pack to maintain flat the top surface of the contracting type ink pack,
wherein the reflection mirror is disposed on the reinforcement plate.

7. The ink level detection apparatus of claim 5, wherein the reflection mirror is a concave reflection mirror.

8. The ink level detection apparatus of claim 5, wherein the light source is an LED or a laser diode.

9. The ink level detection apparatus of claim 5, wherein the light receiving sensor has a high sensitivity to a wavelength of the light emitted from the light source relative to a different light wavelength.

10. An ink level detection apparatus of an inkjet image forming device, comprising:
an ink tank;
a contracting type ink pack accommodated in the ink tank and having a top surface that is lowered in a substantially horizontal direction as an amount of ink remaining in the contracting type ink pack decreases;
a light source disposed on the top surface of the ink tank to emit light in a substantially parallel direction to the contracting direction;
a convex lens fixed with respect to the light source and disposed in an optical path of the light emitted from the light source; and
a light receiving sensor fixed with respect to the ink tank to sense an intensity of the light emitted from the light source through the convex lens.

11. The ink level detection apparatus of claim 10, wherein the contracting type ink pack comprises:
a reinforcement plate a reinforcement plate disposed on the top surface of the contracting type ink pack to maintain flat the top surface of the contracting type ink pack,
wherein the light source and the convex lens are fixed onto the reinforcement plate.

12. The ink level detection apparatus of claim 10, wherein the light source is an LED or a laser diode.

13. The ink level detection apparatus of claim 10, wherein the light receiving sensor has a high sensitivity to a wavelength of the light emitted from the light source relative to a different light wavelength.

14. A detecting unit to detect an ink level in an image forming apparatus, comprising:
a light emitting unit to emit light having a spectrum of intensities;
a light receiving unit to receive a portion of the light emitted by the light generating unit and to generate electrical signals corresponding to an intensity of the received portion of the light; and
a control unit to determine an ink level using the electrical signals.

15. The detecting unit of claim 14, wherein the intensity of the received portion of light corresponds to a distance between the light emitting unit and the light receiving unit.

16. The detecting unit of claim 14, wherein the control unit continuously determines the ink level at predetermined time intervals.

17. The detecting unit of claim 14, wherein the intensity of the received portion of the light has a predetermined relationship with a size of an ink storage unit to store the ink.

18. The detecting unit of claim 14, wherein a position of the light emitting unit is moveable with respect to the ink level.

19. The detecting unit of claim 18, wherein the moveable light emitting unit emits the light directly towards the light receiving unit.

20. The detecting unit of claim 14, wherein a position of the light emitting unit is fixed with respect to the ink level.

21. The detecting unit of claim 20, further comprising:
a light modifying unit to modify the light emitted by the light emitting unit.

22. The detecting unit of claim 21, wherein the light modifying unit comprises:
a reflecting unit to reflect the light emitted by the light emitting unit towards the light receiving unit.

23. The detecting unit of claim 21, wherein the light modifying unit comprises:
a refracting unit to refract the light emitted by the light emitting unit towards the light receiving unit.

24. The detecting unit of claim 14, wherein an intensity of the light emitted by the light emitting unit decreases in proportion to an increase in a distance between the light emitting unit to the light receiving unit.

25. The detecting unit of claim 14, wherein an intensity of the light emitted by the light emitting unit decreases in inverse proportion to a square of a distance between the light emitting unit to the light receiving unit.

26. An ink level detection device useable in an image forming apparatus, comprising:
a contractible ink storage part to store ink;
a light receiving part to receive light, to generate electrical signals corresponding to an intensity of the received light, and to determine a level of the ink in the contractible ink storage part using the electrical signals; and
a light emitting part to emit the light towards the light receiving part such that an intensity of the light received by the light receiving part changes as the ink storage part contracts.

27. The detecting unit of claim 26, wherein the intensity of the light corresponds to a distance between the light emitting part and the light receiving part.

28. The ink level detection device of claim 26, wherein the light emitting part emits the light directly to the light receiving part.

29. The ink level detection device of claim 26, wherein the light receiving part continuously determines the ink level in real-time.

30. A method of detecting a level of ink in a deformable ink storage unit of an image forming apparatus, comprising:
emitting light towards a light sensor such that an intensity of the light received by the light sensor changes as a shape of the ink storage part changes;
generating electrical signals corresponding to the intensity of the received light; and
determining a level of the ink in the deformable ink storage part using the electrical signals.

31. The detecting unit of claim 30, wherein the intensity of the received light corresponds to a size of the deformable ink storage part.
